(19) United States
(12) Patent Application Publication
(10) Pub. No.: US 2009/0021682 A1
(43) Pub. Date: Jan. 22, 2009

(54) LCD PANEL

(75) Inventors: Shui-Chih LIEN, Hsinchu City (TW); Chih Jen HU, Hsinchu City (TW)

Correspondence Address: INGRASSIA FISHER & LORENZ, P.C., 7010 E. COCHISE ROAD, SCOTTSDALE, AZ, 85253, US

(73) Assignee: AU OPTRONICS CORPORATION, Hsin-Chu (TW)

(21) Appl. No.: 12/138,090

(22) Filed: Jun. 12, 2008

(30) Foreign Application Priority Data
Jul. 17, 2007 (TW) 96125982

(51) Int. Cl. G02F 1/1337

(52) U.S. Cl. 349/128

(57) ABSTRACT

A LCD panel is disclosed. The LCD panel has an upper substrate and a lower substrate substantially parallel to the upper substrate. A common electrode is disposed on the upper substrate, and a pixel electrode is disposed on the lower substrate. A first alignment layer, having a first rubbing direction, is disposed on the common electrode, and a second alignment layer, having a second rubbing direction, is disposed on the pixel electrode. The first rubbing direction and the second rubbing direction form a first angle. A liquid crystal layer is disposed between the upper substrate and the lower substrate, and an alignment structure, having an extending direction, is disposed between the common electrode and the liquid crystal layer. The extending direction and the first rubbing direction form a second angle, and the extending direction and the second rubbing direction form a third angle. The second angle is substantially equal to the third angle.

### CROSS REFERENCE TO RELATED APPLICATION

This patent application claims the right of priority based on Taiwan Patent Application No. 96125982 entitled “LCD PANEL”, filed on Jul. 17, 2007, the disclosure of which is incorporated herein by reference in its entirety.

### FIELD OF INVENTION

The present invention relates to an LCD panel, and more particularly, to an LCD panel with wide viewing angle, which resolves the Gray level inversion phenomenon.

### BACKGROUND OF THE INVENTION

LCD technology is widely used in various consumer electronic products, for example, notebook computers, PDAs, mobile phones, etc., due to several advantages such as high portability, low power consumption, zero radioactive pollution, and so on, and has become very popular. In recent years, LCDs have even taken the place of cathode-ray tube (CRT) displays used in traditional desktop computers. However, LCD display performance is affected due to several reasons, such as the Gray level inversion, thus the viewing angle of LCD display is significantly limited.

For example, the Normally White type LCD display with Twisted-Nematic (TN) liquid crystal, Mixed mode Twisted Nematic (MTN) liquid crystal, or Electrically Controlled Birefringence (ECB) liquid crystal, and the Normal Black type LCD display with Vertical Align (VA) liquid crystal etc, all have serious problem with the Gray level inversion. Regarding the above problems, although some techniques related to wide viewing angle have been provided in the recent years, the limitations of the alignment process still make users see different liquid crystal alignment at different viewing angle, which results in the Gray level inversion.

Accordingly, it is advantageous to provide an LCD with wide viewing angle and a method to solve the above problems at low cost and easily be implemented.

### SUMMARY OF THE INVENTION

According to an aspect of the present invention, an LCD panel is disclosed. The LCD panel has an upper substrate and a lower substrate substantially parallel to the upper substrate. A common electrode is disposed on the upper substrate and a pixel electrode is disposed on the lower substrate. A first alignment layer, having a first rubbing direction, is disposed on the common electrode, and a second alignment layer, having a second rubbing direction, is disposed on the pixel electrode. The first rubbing direction and the second rubbing direction form a first angle. A liquid crystal layer is disposed between the upper substrate and the lower substrate. An alignment structure, having an extending direction, is disposed between the common electrode and the liquid crystal layer. The extending direction and the first rubbing direction form a second angle, and the extending direction and the second rubbing direction form a third angle. The second angle is substantially equal to the third angle.

According to another embodiment of the present invention, an LCD can further include a planarization layer located between the upper substrate and the common electrode.

According to another embodiment of the present invention, the alignment structure of the LCD panel is a protrusion protruding from the common electrode toward the liquid crystal layer.

According to another embodiment of the present invention, the planarization layer has a strip groove for accommodating the alignment structure.

According to another embodiment of the present invention, the LCD panel further includes a filter layer located between the upper substrate and the common electrode.

According to another embodiment of the present invention, the LCD panel further includes a light-shielding layer located between the alignment structure and the upper substrate, overlapping at least part of the alignment structure.

According to another embodiment of the present invention, the LCD panel further includes a light-shielding layer located between the pixel electrode and the lower substrate, overlapping at least part of the alignment structure.

According to another embodiment of the present invention, the LCD panel further includes a common conductive line located below the lower substrate, corresponding to at least one edge of the pixel electrode for blocking the passing light.

According to another aspect of the present invention, an LCD panel is disclosed. The LCD panel has an upper substrate and a lower substrate substantially parallel to the upper substrate. A common electrode is disposed on the upper substrate and a pixel electrode is disposed on the lower substrate. A first alignment layer, having a first rubbing direction, is disposed on the common electrode, and a second alignment layer, having a second rubbing direction, is disposed on the pixel electrode. The first rubbing direction and the second rubbing direction form a first angle. A liquid crystal layer is disposed between the upper substrate and the lower substrate. An alignment structure, having an extending direction, is disposed between the common electrode and the liquid crystal layer. The extending direction and the first rubbing direction form a second angle, and the extending direction and the second rubbing direction form a third angle. The second angle is less than the third angle.

According to another aspect of the present invention, an LCD panel is disclosed. The LCD panel has an upper substrate and a lower substrate substantially parallel to the upper substrate. A common electrode is disposed on the upper substrate and a pixel electrode is disposed on the lower substrate. A first alignment layer, having a first rubbing direction, is disposed on the common electrode, and a second alignment layer, having a second rubbing direction, is disposed on the pixel electrode. The first rubbing direction and the second rubbing direction form a first angle. A liquid crystal layer is disposed between the upper substrate and the lower substrate, and an alignment structure, having an extending direction, is disposed between the common electrode and the liquid crystal layer. The extending direction and the first rubbing direction form a second angle, and the extending direction and the second rubbing direction form a third angle. The second angle is larger than the third angle.

### BRIEF DESCRIPTION OF THE DRAWINGS

FIG. 1 illustrates a cross-sectional view of an LCD panel according to an embodiment of the present invention;

FIG. 2 illustrates another cross-sectional view of an LCD panel according to an embodiment of the present invention;

FIGS. 3A-3C illustrate several embodiments of rubbing alignment process and alignment structure;

FIG. 4 illustrates a cross-sectional view of an LCD panel according to another embodiment of the present invention;

FIG. 5 illustrates a cross-sectional view of an LCD panel according to another embodiment of the present invention;

FIG. 6A illustrates a cross-sectional view of an LCD panel according to another embodiment of the present invention;

FIG. 6B illustrates a top view of an LCD panel shown in FIG. 6A;

FIGS. 7A-11C illustrate several embodiments of rubbing alignment process and alignment structure for different liquid crystals; and

FIGS. 12A-12C illustrate the pixel arrangement of an LCD panel according to an embodiment of the present invention.

### DETAILED DESCRIPTION OF THE INVENTION

The above description and the other aspects, features and advantages of the present invention will be more apparent with the following description and the accompanying drawings of various more specific embodiments, wherein the similar reference numbers usually indicate similar components in the embodiments of the present invention. The present invention is not limited to the detail description of specific embodiments.

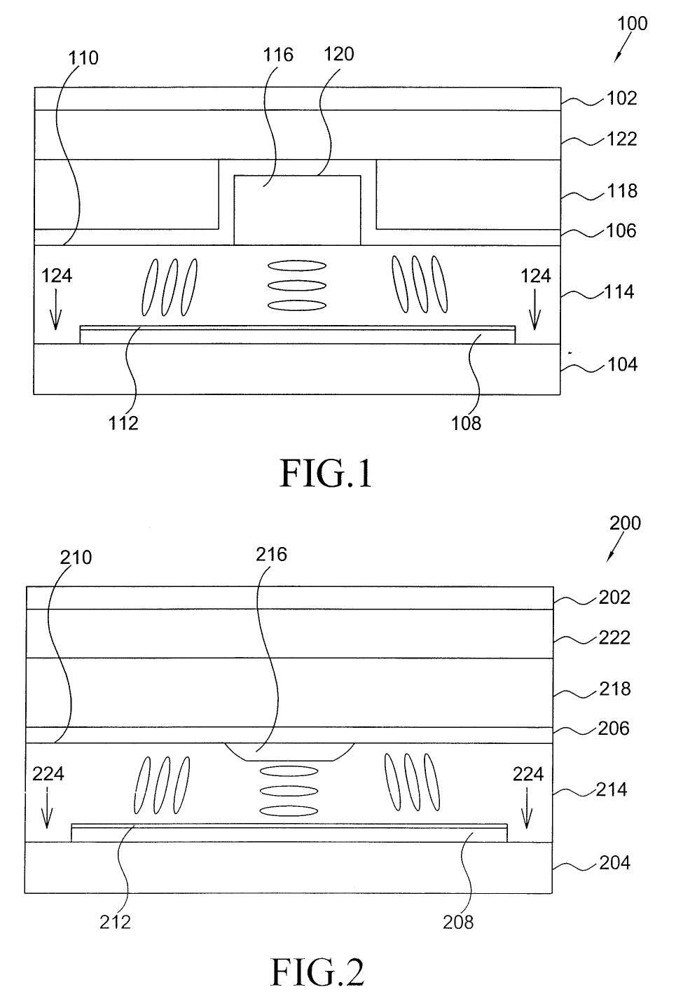

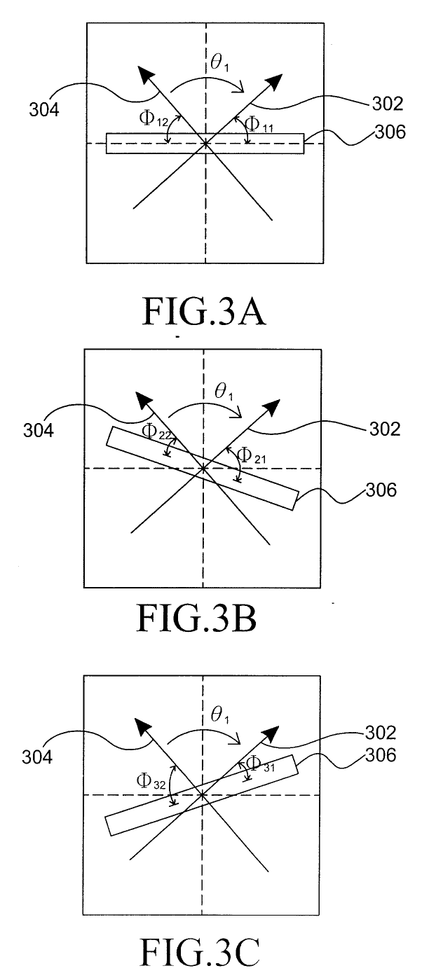

FIG. 1 illustrates a cross-sectional view of an LCD panel 100 according to an embodiment of the present invention. The LCD panel 100 has an upper substrate 102 and a lower substrate 104, wherein the lower substrate 104 is substantially parallel to the upper substrate 102. A common electrode 106 is disposed on the upper substrate 102 and a pixel electrode 108 is disposed on the lower substrate 104. A first alignment layer 110, having a first rubbing direction 302 (as shown in FIGS. 3A-3B), is disposed on the common electrode 106. A second alignment layer 112, having a second rubbing direction 304 (as shown in FIGS. 3A-3B), is disposed on the pixel electrode 108. The first alignment layer 110 and the second alignment layer 112 can be formed by using various well known alignment methods, for example, rubbing alignment, optical alignment, ion alignment, or chemical alignment, etc. A liquid crystal layer 114 is disposed between the upper substrate 102 and the lower substrate 104. An alignment structure 116, having an extending direction 306 (as shown in FIGS. 3A-3B), is disposed between the common electrode 106 and the liquid crystal layer 114. A planarization layer 118 is located between the upper substrate 102 and the common electrode 106, wherein the planarization layer 118 has a strip groove 120 for accommodating the alignment structure 116. The LCD panel 100 can further include a filter layer 122 located between the upper substrate 102 and the common electrode 106. Filter layer 122 may be a color filter layer.

According to the alignment structure 116 and the electric field controlled by the multi-domain structure of the edge of the pixel electrode 108, cooperating with the first alignment layer 110 and the second alignment layer 112 produced from the alignment process, the liquid crystal of the liquid crystal layer 114 can present the effect of multi-domain arrangement, thus a LCD panel with wide viewing angle can be achieved. The rubbing alignment process will be described below.

FIGS. 3A-3C illustrate several embodiments of rubbing alignment process and alignment structure. Twisted-Nematic (TN) liquid crystal is used for example in the liquid crystal layer 114 of the embodiments in FIGS. 3A-3C. Referring to FIG. 3A first, the first alignment layer 110 has the first rubbing direction 302 and the second alignment layer 112 has the second rubbing direction 304 from an alignment process. The first rubbing direction 302 and the second rubbing direction 304 form a first angle θ1. In this embodiment, the first angle θ1 is between about 80 degrees and about 110 degrees, preferably about 90 degrees. The extending direction 306 and the first rubbing direction 302 form a second angle φ11, and the extending direction 306 and the second rubbing direction 304 form a third angle φ12, wherein the second angle φ11 is substantially equals to the third angle φ12.

In another embodiment shown in FIG. 3B, the first rubbing direction 302 and the second rubbing direction 304 form the first angle θ1 as in FIG. 3A. The extending direction 306 and the first rubbing direction 302 form the second angle φ21, and the extending direction 306 and the second rubbing direction 304 form a third angle φ22, wherein the second angle φ21 is larger than the third angle φ22. In another embodiment shown in FIG. 3C, the extending direction 306 and the first rubbing direction 302 form the second angle φ31, and the extending direction 306 and the second rubbing direction 304 form a third angle φ32, wherein the second angle φ31 is less than the third angle φ32. It should be noted that the angle between the extending direction 306 and a trench produced by rubbing in the alignment process is substantially the same as the angle between the extending direction 306 and the rubbing direction while a tolerance of ±20 degrees is acceptable.

FIG. 2 is a cross-sectional view of an LCD panel 200 according to another embodiment of the present invention. The LCD panel 200 has an upper substrate 202 and a lower substrate 204, wherein the lower substrate 204 is substantially parallel to the upper substrate 202. A common electrode 206 is disposed on the upper substrate 202, and a pixel electrode 208 is disposed on the lower substrate 204. A first alignment layer 210, having a first rubbing direction 302 (as shown in FIGS. 3A-3B), is disposed on the common electrode 206. A second alignment layer 212, having a second rubbing direction 304 (as shown in FIGS. 3A-3B), is disposed on the pixel electrode 208. A liquid crystal layer 214 is disposed between the upper substrate 202 and the lower substrate 204. An alignment structure 216, having an extending direction 306 (as shown in FIGS. 3A-3B), is disposed between the common electrode 206 and the liquid crystal layer 214. A planarization layer 218 is located between the upper substrate 202 and the common electrode 206. Different from the embodiment in FIG. 1, the alignment structure 216 is a protrusion protruding from the common electrode 206 toward the liquid crystal layer 214. The LCD panel 200 may further include a filter layer 222 located between the upper substrate 202 and the common electrode 206.

Therefore, by using the electric field controlled by the alignment structure, cooperating with the trench produced from the rubbing alignment process, a multi-domain control effect can be achieved to increase the viewing angle of an LCD display. Besides the description mentioned above, the present invention still can have many different modifications and variations in other embodiments.

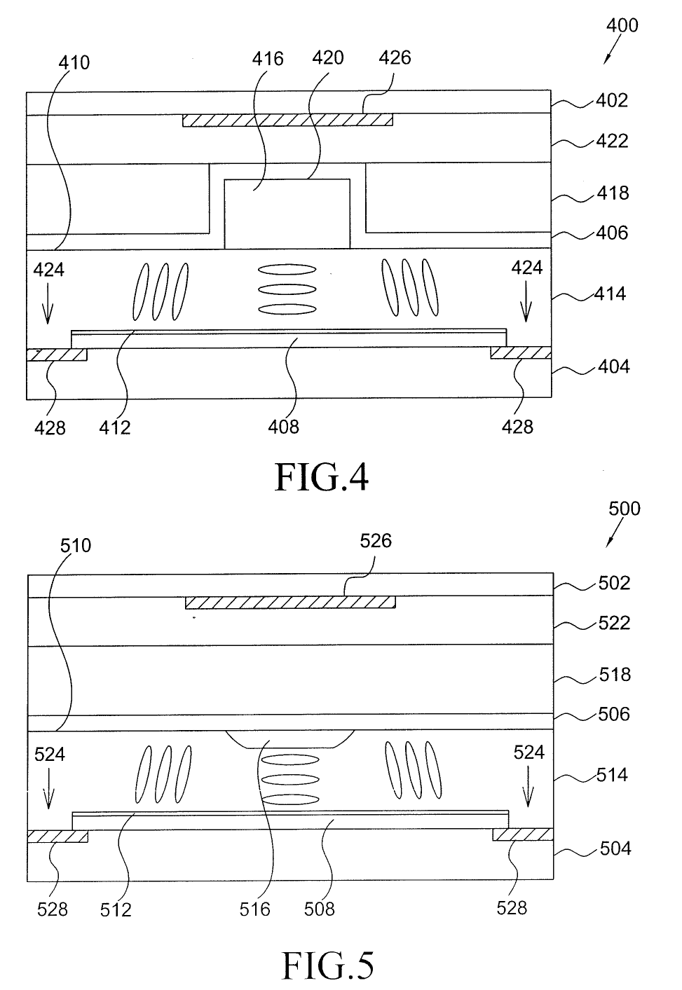

FIG. 4 illustrates a cross-sectional view of an LCD panel 400 according to another embodiment of the present invention. The LCD panel 400 has an upper substrate 402, a lower substrate 404, a common electrode 406, a pixel electrode 408, a first alignment layer 410, a second alignment layer 412, a liquid crystal layer 414, an alignment structure 416, a planarization layer 418 having a strip groove 420, and a filter layer 422. The LCD panel 400 is similar to the LCD panel 100 shown in FIG. 1, therefore the similarities are omitted here for conciseness. The LCD panel 400 further has a light-shielding layer 426 located between the alignment structure 416 and the upper substrate 402; and a common conductive line 428 located on the lower substrate 404. The location of the light-shielding layer 426 corresponds to the alignment structure 416, and overlaps at least part of the alignment structure 416. The common conductive line 428 corresponds to the edge 424 of the pixel electrode 408, for blocking the passing light, to reduce the potential light leakage in the liquid crystal multi-domain structure.

FIG. 5 illustrates a cross-sectional view of an LCD panel 500 according to another embodiment of the present invention. The LCD panel 500 has an upper substrate 502, a lower substrate 504, a common electrode 506, a pixel electrode 508, a first alignment layer 510, a second alignment layer 512, a liquid crystal layer 514, an alignment structure with protrusion 516, a planarization layer 518, and filter layer 522. The LCD panel 500 is similar to the LCD panel 200 as shown in FIG. 2, therefore the similarities are omitted here for conciseness. The LCD panel 500 further has a light-shielding layer 526 located between the alignment structure 516 and the upper substrate 502; and a common conductive line 528 located on the lower substrate 504. The light-shielding layer 526 overlaps at least part of the alignment structure 516. The common conductive line 528 corresponds to the edge 524 of the pixel electrode 508, for blocking the passing light, to reduce the potential light leakage in the liquid crystal multi-domain structure.

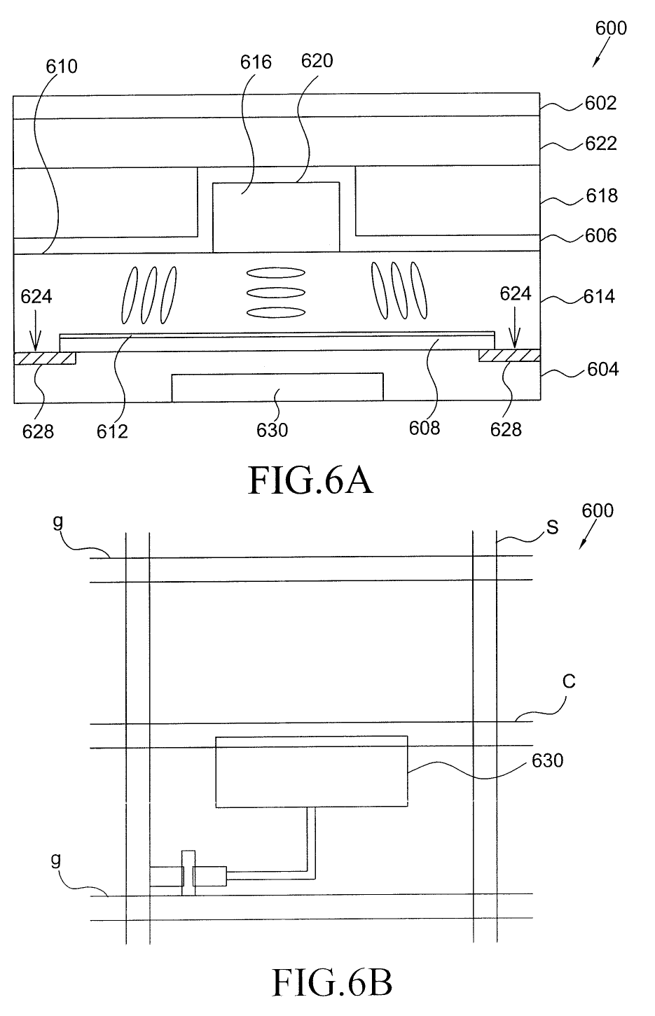

FIG. 6A illustrates a cross-sectional view of an LCD panel 600 according to another embodiment of the present invention. The LCD panel 600 has an upper substrate 602, a lower substrate 604, a common electrode 606, a pixel electrode 608, a first alignment layer 610, a second alignment layer 612, a liquid crystal layer 614, an alignment structure 616, a planarization layer 618 having a strip groove 620, and a filter layer 622. The LCD panel 600 is similar to the LCD panel 100 as shown in FIG. 1, therefore the similarities are omitted here for conciseness. The LCD panel 600 further has a light-shielding layer 630 located between the pixel electrode and the lower substrate 604, and a common conductive line 628 located on the lower substrate 604. The location of the light-shielding layer 626 corresponds to the alignment structure 616, and overlaps at least part of the alignment structure 616. The common conductive line 628 corresponds to the edge 624 of the pixel electrode 608, for blocking the passing light, to reduce the potential light leakage in the liquid crystal multi-domain structure. FIG. 6B is a top view of the LCD panel 600 in FIG. 6A. In the present embodiment, a capacitor structure of the LCD panel 600 is disposed corresponding to the alignment structure 616 to serve as the light-shielding layer 630; however, the present invention is not limited to this arrangement.

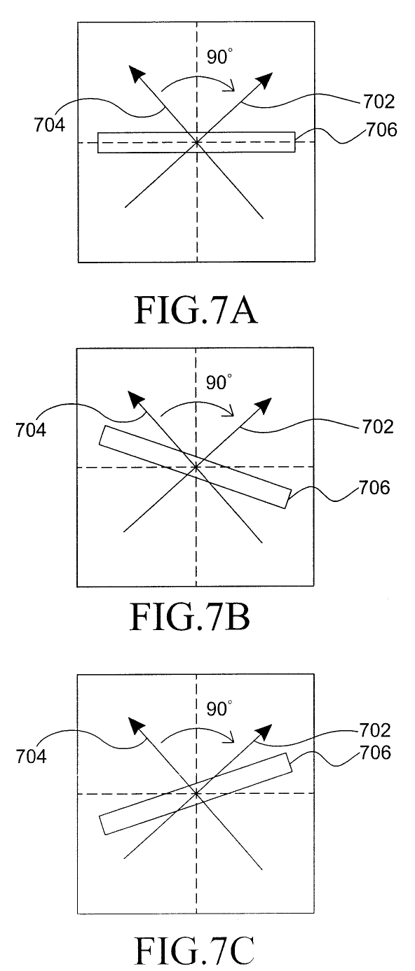

It should be noted that besides adding the masking layer to the structure to block the light in the embodiments mentioned above, the present invention may be implemented in various ways. FIGS. 7A-11C gives examples for several possible methods to be applied in the present invention for different type liquid crystal layers.

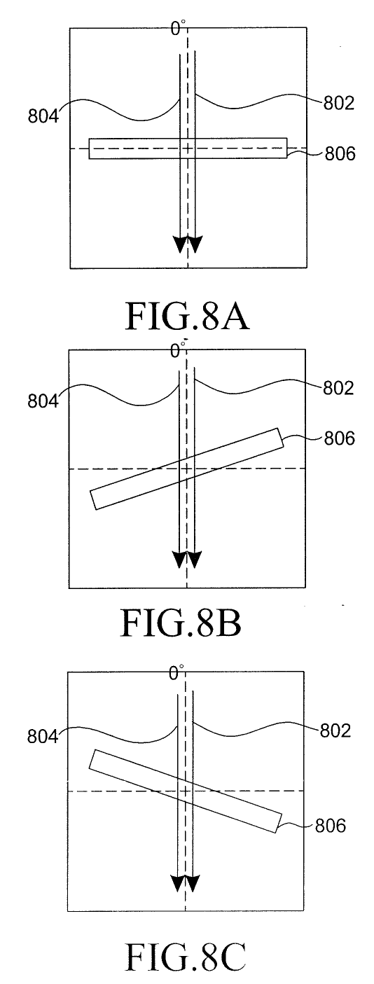

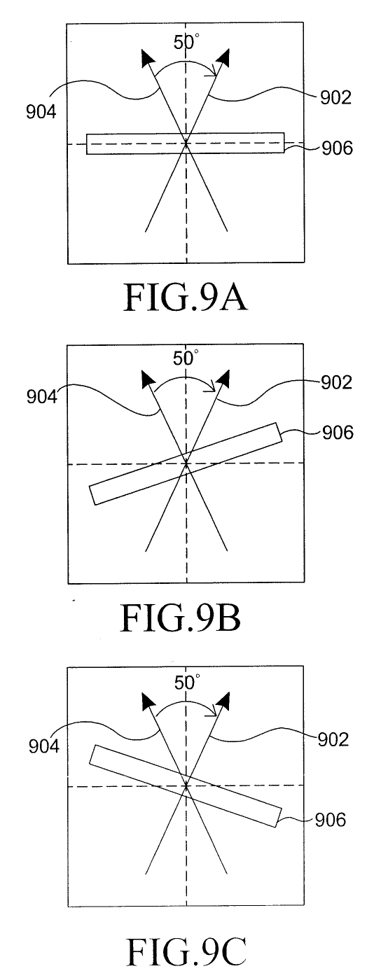

In FIGS. 7A-9C, the liquid crystal layer uses the Vertical Align (VA) liquid crystal as exemplary embodiments. In FIGS. 7A-7C, the first rubbing direction 702 and the second rubbing direction 704 form a first angle. The first angle is between about 80 degrees and about 110 degrees, preferably about 90 degrees. The extending direction 706 and the first rubbing direction 702 formed a second angle, respectively substantially equal to, larger and less than a third angle formed by the extending direction 706 and the second rubbing direction 704 corresponding to FIGS. 7A-7C. In FIGS. 8A-8C, the first rubbing direction 802 and the second rubbing direction 804 form a first angle, which is between about −10 degrees and about 10 degrees, and preferably 0 degree. The extending direction 806 and the first rubbing direction 802 form a second angle, which is substantially equal to, larger and less than a third angle formed by the extending direction 806 and the second rubbing direction 804 corresponding to FIGS. 8A-8C. In FIGS. 9A-9C, the first rubbing direction 902 and the second rubbing direction 904 form a first angle, which is less than 90 degrees, and preferably about 50 degrees. The extending direction 906 and the first rubbing direction 902 form a second angle, which is substantially equal to, larger and less than a third angle formed by the extending direction 906 and the second rubbing direction 904 corresponding to FIGS. 9A-9C.

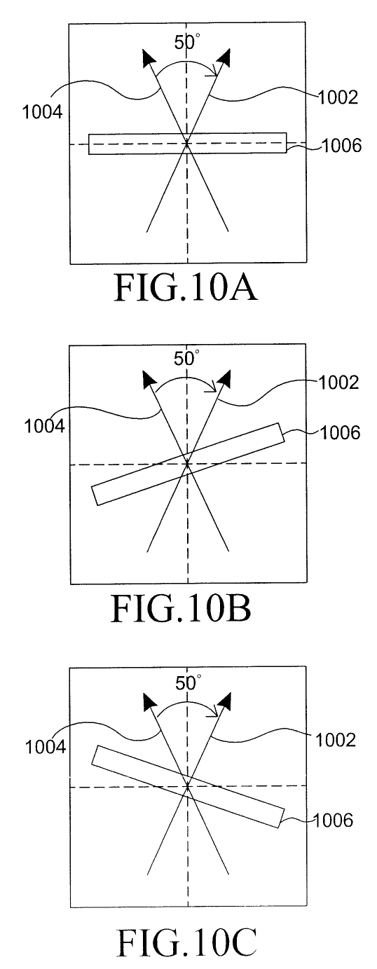

In FIGS. 10A-10C, the liquid crystal layer uses the Mixed mode Twisted Nematic (MTN) liquid crystal as exemplary embodiments. In FIGS. 10A-10C, the first rubbing direction 1002 and the second rubbing direction 1004 form a first angle, which is smaller than about 90 degrees, preferably 50 degrees. The extending direction 1006 and the first rubbing direction 1002 form a second angle, which is substantially equal to, larger and less than a third angle formed by the extending direction 1106 and the second rubbing direction 1104 corresponding to FIGS. 10A-10C.

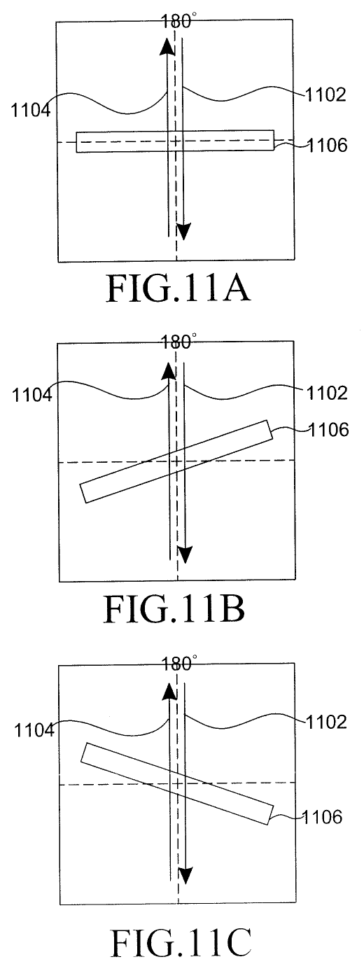

In FIGS. 11A-11C, the liquid crystal layer uses the Electrically Controlled Birefringence (ECB) liquid crystal. In FIGS. 11A-11C, the first rubbing direction 1102 and the second rubbing direction 1104 form a first angle, which is between about −10 degrees and about 10 degrees, preferably about 0 degree. The extending direction 1106 and the first rubbing direction 1102 form a second angle, which is substantially equal to, larger and less than a third angle formed between the extending direction 1106 and the second rubbing direction 1104 corresponding to FIGS. 11A-11C.

From the description mentioned above, through the rubbing alignment process, the present invention can be easily implemented in various different liquid crystal LCD panels, for example but not limited to, Twisted-Nematic (TN) liquid crystal, Mixed mode Twisted Nematic (MTN) liquid crystal, Electrically Controlled Birefringence (ECB) liquid crystal, or Vertical Align (VA) liquid crystal. The first rubbing direction, the second rubbing direction, and the extending direction of the alignment structure can have various different arrangements when considering different design purposes for different liquid crystals.

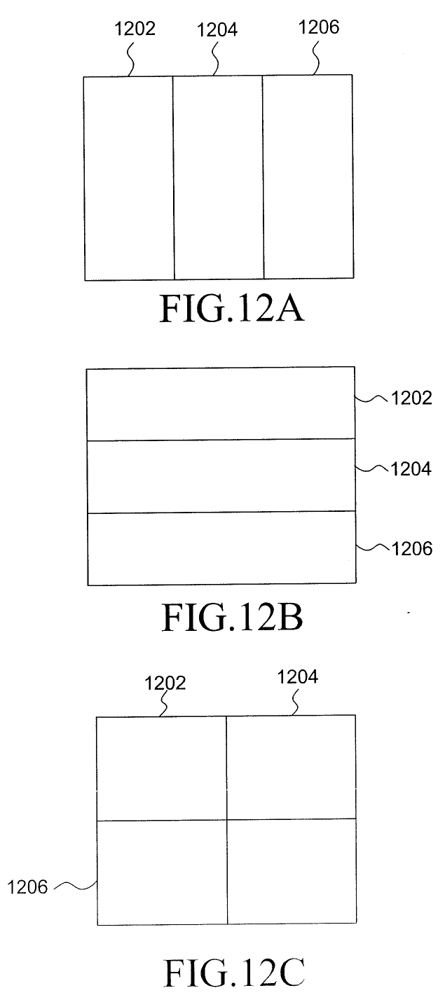

FIGS. 12A-12C illustrate the pixel arrangement of an LCD panel according to an embodiment of the present invention. It should be noted that three pixels are used for illustration, however, for those skilled in the art should understand that this is for illustration rather limitation. That is, the embodiment of the present invention can have other number of pixel(s) without impacting the implementation of the present invention. There are three pixels in FIG. 12A, i.e. pixels 1202, 1204 and 1206, displaying three different colors respectively, for example, red, green and blue, arranged in vertical. In FIG. 12B, pixels 1202, 1204 and 1206 are arranged in horizontal, displaying three different colors respectively, for example, red, green and blue. In FIG. 12C, pixels are arranged in matrix.

The above embodiments are used to illustrate the present invention, however, the present invention is not limited to the description of the above-specified embodiments. Equivalent amendments and modifications without departing from the spirit of the invention should be included in the scope of the following claims.

1. An LCD panel, comprising:
an upper substrate;
a lower substrate substantially parallel to the upper substrate;
a common electrode disposed on the upper substrate;
a pixel electrode disposed on the lower substrate;
a first alignment layer, having a first rubbing direction, disposed on the common electrode;
a second alignment layer, having a second rubbing direction, disposed on the pixel electrode, wherein the first rubbing direction and the second rubbing direction form a first angle;
a liquid crystal layer disposed between the upper substrate and the lower substrate; and
an alignment structure, having an extending direction, disposed between the common electrode and the liquid crystal layer, wherein the extending direction and the first rubbing direction form a second angle, and the extending direction and the second rubbing direction form a third angle, and wherein the second angle is substantially equal to the third angle.

2. The LCD panel according to claim 1, further comprising a planarization layer located between the upper substrate and the common electrode, wherein the planarization layer has a strip groove to accommodate the alignment structure.

3. The LCD panel according to claim 1, wherein the alignment structure is a protrusion protruding from the common electrode toward the liquid crystal layer.

4. The LCD panel according to claim 1, wherein the first angle is between about 80 degrees and about 110 degrees.

5. The LCD panel according to claim 1, wherein the first angle is less than about 90 degrees.

6. The LCD panel according to claim 1, wherein the first angle is between about −10 degrees and about 10 degrees.

7. The LCD panel according to claim 1, wherein the liquid crystal layer comprises Twisted-Nematic (TN) liquid crystal, Mixed mode Twisted Nematic (MTN) liquid crystal, Electrically Controlled Birefringence (ECB) liquid crystal, or Vertical Align (VA) liquid crystal.

8. The LCD panel according to claim 1, further comprising a light-shielding layer located between the alignment structure and the upper substrate, overlapping at least part of the alignment structure.

9. The LCD panel according to claim 1, further comprising a light-shielding layer located between the pixel electrode and the lower substrate, overlapping at least part of the alignment structure.

10. An LCD panel, comprising:
an upper substrate;
a lower substrate substantially parallel to the upper substrate;
a common electrode disposed on the upper substrate;
a pixel electrode disposed on the lower substrate;
a first alignment layer, having a first rubbing direction, disposed on the common electrode;
a second alignment layer, having a second rubbing direction, disposed on the pixel electrode, wherein the first rubbing direction and the second rubbing direction form a first angle;
a liquid crystal layer disposed between the upper substrate and the lower substrate; and
an alignment structure, having an extending direction, disposed between the common electrode and the liquid crystal layer, wherein the extending direction and the first rubbing direction form a second angle, and the extending direction and the second rubbing direction form a third angle, and wherein the second angle is less than the third angle.

11. The LCD panel according to claim 10, further comprising a planarization layer located between the upper substrate and the common electrode, wherein the planarization layer has a strip groove to accommodate the alignment structure.

12. The LCD panel according to claim 10, wherein the alignment structure is a protrusion protruding from the common electrode toward the liquid crystal layer.

13. The LCD panel according to claim 10, wherein the first angle is between about 80 degrees and about 110 degrees.

14. The LCD panel according to claim 10, wherein the first angle is less than about 90 degrees.

15. The LCD panel according to claim 10, wherein the first angle is between about −10 degrees and about 10 degrees.

16. The LCD panel according to claim 10, wherein the liquid crystal layer comprises Twisted-Nematic (TN) liquid crystal, Mixed mode Twisted Nematic (MTN) liquid crystal, Electrically Controlled Birefringence (ECB) liquid crystal, or Vertical Align (VA) liquid crystal.

17. The LCD panel according to claim 10, further comprising a light-shielding layer located between the alignment structure and the upper substrate, overlapping at least part of the alignment structure.

18. The LCD panel according to claim 10, further comprising a light-shielding layer located between the pixel electrode and the lower substrate, overlapping at least part of the alignment structure.

19. An LCD panel, comprising:
an upper substrate;
a lower substrate substantially parallel to the upper substrate;
a common electrode disposed on the upper substrate;
a pixel electrode disposed on the lower substrate;
a first alignment layer, having a first rubbing direction, disposed on the common electrode;
a second alignment layer, having a second rubbing direction, disposed on the pixel electrode, wherein a first angle is formed between the first rubbing direction and the second rubbing direction;
a liquid crystal layer disposed between the upper substrate and the lower substrate; and
an alignment structure, having an extending direction, disposed between the common electrode and the liquid crystal layer, wherein the extending direction and the first rubbing direction form a second angle, and the extending direction and the second rubbing direction form a third angle, and wherein the second angle is larger than the third angle.

20. The LCD panel according to claim 19, further comprising a planarization layer located between the upper substrate and the common electrode, wherein the planarization layer has a strip groove to accommodate the alignment structure.

21. The LCD panel according to claim 19, wherein the alignment structure is a protrusion protruding from the common electrode toward the liquid crystal layer.

22. The LCD panel according to claim 19, wherein the first angle is between about 80 degrees and about 110 degrees.

23. The LCD panel according to claim 19, wherein the first angle is less than about 90 degree.

24. The LCD panel according to claim 19, wherein the first angle is about between −10 degree and 10 degree.

25. The LCD panel according to claim 19, wherein the liquid crystal layer comprises Twisted-Nematic (TN) liquid crystal, Mixed mode Twisted Nematic (MTN) liquid crystal, Electrically Controlled Birefringence (ECB) liquid crystal, or Vertical Align (VA) liquid crystal.
